(19) United States
(12) Patent Application Publication
(10) Pub. No.: US 2026/0136160 A1
(43) Pub. Date: May 14, 2026

(54) SENSOR DATA COLLECTION SYSTEM, METHOD AND PROGRAM

(71) Applicant: NTT, Inc., Tokyo (JP)

(72) Inventors: Kenichi Matsunaga, Tokyo (JP); Akio Tokura, Tokyo (JP); Kazuhiko Takagahara, Tokyo (JP)

(21) Appl. No.: 19/134,427

(22) PCT Filed: Dec. 1, 2022
(86) PCT No.: PCT/JP2022/044366

§ 371 Date: May 30, 2025

(51) Int. Cl. H04W 4/38

(52) U.S. Cl. CPC H04W 4/38

(57) ABSTRACT

A sensor data collection system includes a sensor device configured to wirelessly transmit sensor data and a receiver configured to receive the sensor data. The sensor device includes a first communication controller, a first memory that stores the sensor data, and a data storage device. The receiver includes a second communication controller. The first communication controller wirelessly transmits the sensor data when communication is continued, and performs disconnection processing when communication is not possible or when a disconnection command is received. The data storage device stores the sensor data in the first memory when communication is disconnected and the disconnection is not caused by receipt of the disconnection command. The second communication controller performs disconnection processing when communication with the sensor device is not possible, and performs disconnection processing and wirelessly transmits the disconnection command when an operation end instruction is received from a host device.

### CROSS-REFERENCE TO RELATED APPLICATIONS

This application is a national phase entry of PCT Application No. PCT/JP 2022/044366, filed on Dec. 1, 2022, which application is hereby incorporated herein by reference.

### TECHNICAL FIELD

The present invention relates to a sensor data collection system, a method, and a program for wirelessly collecting sensor data from a sensor device.

### BACKGROUND

In an Internet of Things (IoT) society in which all things are connected to the Internet, various kinds of sensors are connected to a network, and it is expected to extract information useful for humans by collecting a large amount of data and analyzing the data. When sensor data acquired by a sensor is collected, wireless data transfer is generally required in order to improve a degree of freedom of installation, and in particular, in a case where biometric data is collected, wireless communication contributes to improvement in convenience (Non Patent Literature 1).

In addition, in related art, it has been required to collect sensor data using a smartphone of each individual, but in order to meet the needs of users who do not want or do not have a smartphone, a system that does not require a smartphone for collecting sensor data has been proposed (Non Patent Literature 2).

Although wireless transmission of the sensor data is effective in improving convenience, there is a possibility that unexpected data loss occurs when a wireless environment suddenly deteriorates. As a technique for preventing such data loss, a method of storing all data on the sensor side (Non Patent Literature 3), a method by delivery confirmation (Non Patent Literature 4), and the like, are known.

However, the method of storing all the data in the sensor device requires a large-capacity memory for storing a large amount of data, and thus problems such as increase in cost and increase in size of the sensor device are likely to occur. In addition, in the method by the delivery confirmation, while stability of transmission and reception increases, there is a problem that a communication speed is adversely affected by overhead due to the delivery confirmation.

### CITATION LIST

### Non Patent Literature

Non Patent Literature 1: Nahoko Kasai, Takayuki Ogasawara, Hiroshi Nakashima, and Shingo Tsukada, “Development of Functional Textile ”hitoe“: Wearable Electrodes for Monitoring Human Vital Signals”, The Institute of Electronics, Information and Communication Engineers, Communication Society Magazine, Vol. 11, No. 1, pp. 17-23, Jun. 1, 2017, Online ISSN 2186-0661, <https://doi.org/10.1587/bplus.11.17>
Non Patent Literature 2: Kenichi Matsunaga, et al., “Proposal of multi-sensor accommodation data collection technology suitable for IoT”, Institute of Electronics, Information and Communication Engineers, Proceedings of the 2016 Society Conference, B-18-56, page 420
Non Patent Literature 3:“Holter recorder eMEMO WR-100”, medical device package insert, Fukuda Electronics Co., Ltd., November 2020, <https://www.pmda.go.jp/PmdaSearch/kikiDetail/ResultDataSetPDF/670053_228ADBZX001 13000_A_02_01>
Non Patent Literature 4: RFC9293 Transmission Control Protocol(TCP), Internet Engineering Task Force (IETF), August 2022, <https://www.rfc-editor.org/rfc/rfc 9293.html>

### SUMMARY

### Technical Problem

The present invention has been made to solve the above problems, and it is an object of the present invention to provide a sensor data collection system, a method, and a program capable of significantly reducing loss of sensor data in a system that wirelessly collects sensor data and capable of implementing low-cost and stable automatic data collection.

### Solution to Problem

A sensor data collection system of the present invention includes: a sensor device configured to wirelessly transmit sensor data; and a receiver configured to receive the sensor data, the sensor device includes: a first communication control unit configured to control communication with the receiver; a first memory that stores the sensor data; and a data storage unit configured to store the sensor data in the first memory, the receiver includes: a second communication control unit configured to control communication with the sensor device, the first communication control unit of the sensor device wirelessly transmits the sensor data to the receiver in a case where communication with the receiver is being continued, and performs disconnection processing of communication when communication with the receiver is not possible or when a disconnection command is received from the receiver, the data storage unit of the sensor device stores the sensor data in the first memory in a case where communication with the receiver is disconnected and the disconnection is not caused by receipt of the disconnection command, and the second communication control unit of the receiver performs disconnection processing of communication when communication with the sensor device is not possible, and performs disconnection processing of communication and wirelessly transmits the disconnection command to the sensor device that is being connected when an operation end instruction is received from a host device.

### Advantageous Effects of Invention

According to the present invention, a clear distinction is made between disconnection of communication intended by a user of the sensor data collection system and unintended disconnection, and a disconnection command is issued from the receiver to the sensor device in a case of the disconnection intended by the user, and a disconnection command is not issued in a case of the unintended disconnection. In the present invention, the sensor data is stored in the first memory of the sensor device only in a case of the disconnection unintended by the user, and the sensor data is not stored in a case of the disconnection intended by the user. It is therefore possible to reduce a possibility that the first memory becomes tight and operation of the sensor device fails. In addition, in the present invention, in a case where communication is disconnected due to deterioration of a wireless environment, or the like, a disconnection command is not issued from the receiver. It is therefore possible to reliably store the sensor data, and it is possible to significantly reduce loss of sensor data without changing wireless communication standards. The sensor data stored in the first memory can be read later. In the present invention, it is not necessary to store all the sensor data in the first memory, which eliminates the need of a large-capacity memory as in the related art, so that it is possible to reduce cost of the sensor device. In addition, in the present invention, the method by delivery confirmation in the related art is not used, so that a communication speed is not reduced due to the delivery confirmation. In the present invention, it is possible to implement low-cost and stable automatic data collection and to reduce the burden on the user.

### BRIEF DESCRIPTION OF THE DRAWINGS

FIG. 1 is a block diagram illustrating a configuration of a sensor data collection system according to a first embodiment of the present invention.

FIG. 2 is a block diagram illustrating a configuration example of a sensor front end of a sensor device according to the first embodiment of the present invention.

FIGS. 3A and 3B are views for explaining operation of the sensor device according to the first embodiment of the present invention.

FIG. 4 is a flowchart for explaining the operation of the sensor device according to the first embodiment of the present invention.

FIGS. 5A and 5B are views for explaining operation of a receiver according to the first embodiment of the present invention.

FIG. 6 is a flowchart for explaining the operation of the receiver according to the first embodiment of the present invention.

FIG. 7 is a block diagram illustrating a configuration of a sensor data collection system according to a second embodiment of the present invention.

FIG. 8 is a block diagram illustrating a configuration of a receiver according to the second embodiment of the present invention.

FIG. 9 is a flowchart for explaining operation of the receiver according to the second embodiment of the present invention.

FIG. 10 is a flowchart for explaining operation of a receiver control device according to the second embodiment of the present invention.

FIG. 11 is a view for explaining an operation example of the sensor data collection system according to the second embodiment of the present invention.

FIG. 12 is a block diagram illustrating a configuration of a sensor data collection system according to a third embodiment of the present invention.

FIG. 13 is a flowchart for explaining operation of a sensor device according to the third embodiment of the present invention.

FIG. 14 is a flowchart for explaining operation of a receiver according to the third embodiment of the present invention.

FIG. 15 is a flowchart for explaining operation of a receiver according to a fourth embodiment of the present invention.

FIG. 16 is a block diagram illustrating a configuration example of a computer that implements the sensor data collection system according to the first to fourth embodiments of the present invention.

### DETAILED DESCRIPTION OF ILLUSTRATIVE EMBODIMENTS

### Principle of Invention

In wireless communication standards for a sensor such as Bluetooth (registered trademark) low energy (BLE), session information for confirming whether communication is continuously established is defined. In other words, the presence of the session information indicates that the wireless communication is smoothly performed, and the absence of the session information indicates that the wireless communication is disconnected. Thus, in a case where there is no session information, by storing sensor data to be transmitted in a memory included in a sensor device and reading the sensor data later, it is possible to reduce a probability of occurrence of data loss.

However, the session information is generally binary information indicating whether or not communication is being continued. For this reason, it is not possible to distinguish between a situation in which a user of the sensor data collection system has intentionally completed or disconnected the communication and a situation in which the user has unintentionally disconnected the communication due to deterioration of a wireless environment, or the like, based on the session information. Thus, a case will occur where data is stored in the memory of the sensor device even after the user has intentionally disconnected the communication. In a case where data is continuously stored in the memory of the sensor device, there is a possibility that the memory becomes tight and operation of the sensor device fails.

In addition, upon disconnection of communication due to deterioration of the wireless environment, or the like, if a disconnection command is issued from a receiver and the sensor device receives the command, the sensor device may recognize that disconnection of the communication is disconnection intended by the user and may not store data in the memory. However, in a case where communication is disconnected due to deterioration of the wireless environment, or the like, it is desirable to store data in the memory to prevent data loss.

In a case where the sensor data is received by a portable device that receives user operation on a screen, such as a smartphone, it is easy to distinguish between disconnection of communication intended by the user and unintended disconnection. However, in a system that automatically implements data collection without using a device such as a smartphone as in the present invention, it is difficult for a user to make a distinction.

As is clear from the above facts, it is necessary to perform control so that the receiver issues a disconnection command to the sensor device in a case of disconnection processing of communication intended by the user and does not issue a disconnection command in a case of unintended disconnection processing. According to the sensor data collection system of the present invention, it is possible to store the sensor data in the memory built in the sensor device when the wireless environment deteriorates and to stably and automatically read the data later without changing wireless communication standards.

### First Embodiment

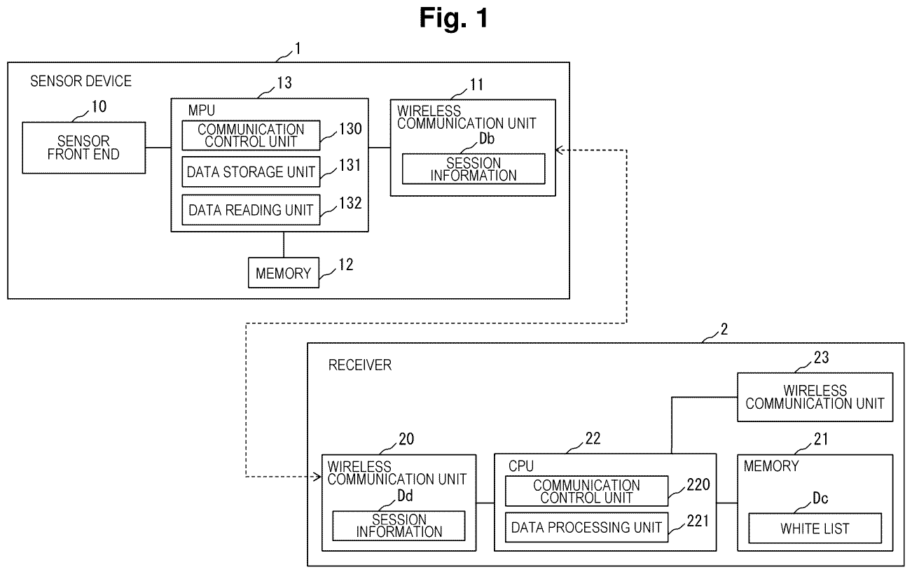

Hereinafter, embodiments of the present invention will be described with reference to the drawings. FIG. 1 is a block diagram illustrating a configuration of a sensor data collection system according to a first embodiment of the present invention. The sensor data collection system includes a sensor device 1 that wirelessly transmits sensor data indicating a measured physical amount, and a receiver 2 that receives the sensor data.

The sensor device 1 includes a sensor front end 10 that outputs the sensor data including information on the measured physical amount, a wireless communication unit 11 for communication with the receiver 2, a memory 12 for storing data and a program, and a micro processing unit (MPU) 13 that controls the entire sensor device.

The MPU 13 executes processing according to the program stored in the memory 12 and functions as a communication control unit 130, a data storage unit 131, and a data reading unit 132.

The receiver 2 includes a wireless communication unit 20 for communication with the sensor device 1, a memory 21 for storing data and a program, a central processing unit (CPU) 22 that controls the entire receiver, and a wireless communication unit 23 for communication with a host device (not illustrated). The receiver 2 is not a portable device, but is, for example, a device installed in a building, and does not have a display function.

The CPU 22 executes processing according to the program stored in the memory 21 and functions as a communication control unit 220 and a data processing unit 221.

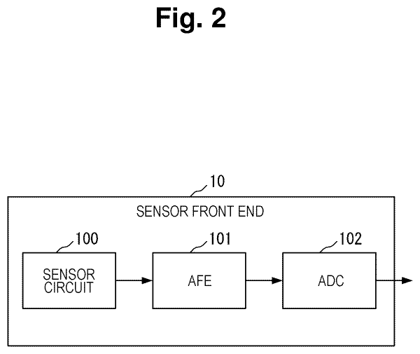

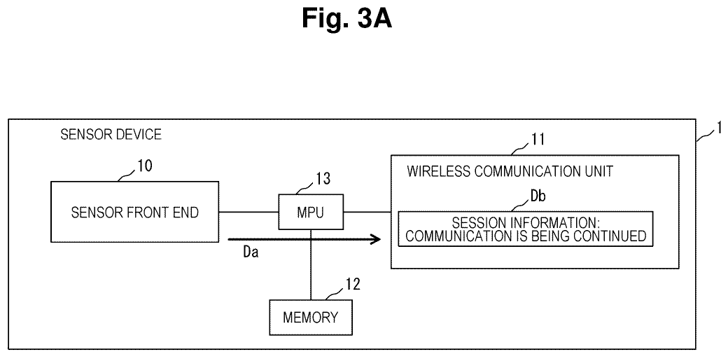

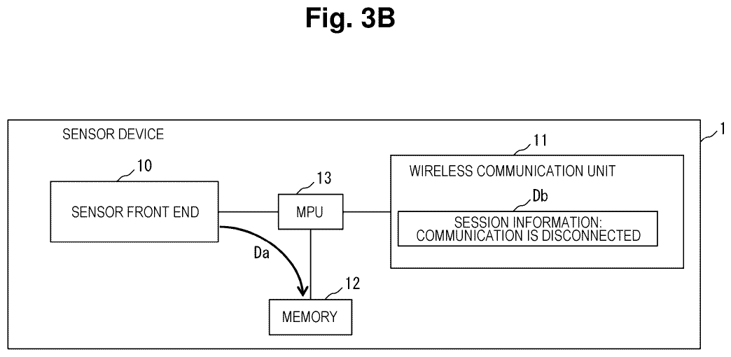

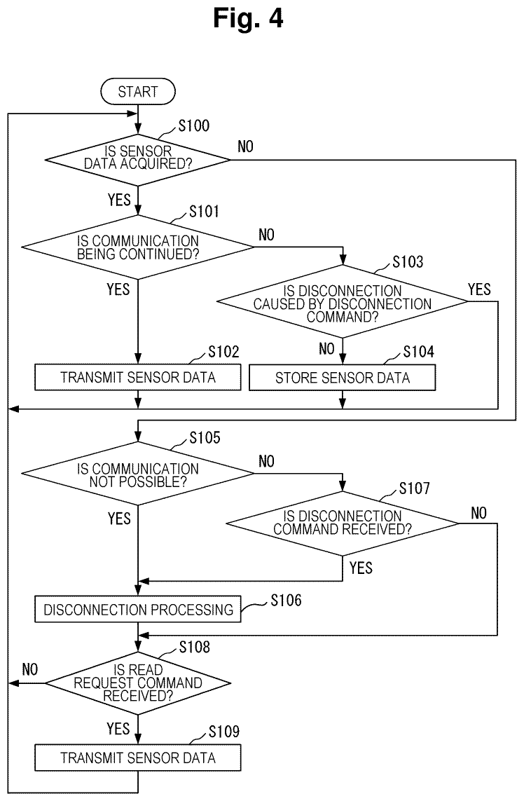

FIG. 2 is a block diagram illustrating a configuration example of the sensor front end 10, FIGS. 3A and 3B are views for explaining operation of the sensor device 1, and FIG. 4 is a flowchart for explaining the operation of the sensor device 1.

The sensor front end 10 of the sensor device 1 includes, for example, a sensor circuit 100 that measures a physical amount such as an acceleration, an angular acceleration, and an electrocardiogram waveform, an analog front end circuit (AFE) 101 that performs processing such as amplification and noise removal of an analog signal output from the sensor circuit 100, and an analog to digital (AD) converter (ADC) 102 that converts the analog signal output from the AFE 101 into digital data and outputs the digital data.

The MPU 13 of the sensor device 1 acquires sensor data Da output from the sensor front end 10 (step S100 in FIG. 4).

The communication control unit 130 of the sensor device 1 refers to session information Db managed by the wireless communication unit 11, and in a case where the session information Db indicates that communication with the receiver 2 is being continued (step S101 in FIG. 4: Yes), stores the sensor data Da acquired from the sensor front end 10 in a packet and passes the packet to the wireless communication unit 11 (FIG. 3A). The wireless communication unit 11 wirelessly transmits the packet received from the communication control unit 130 to the receiver 2 that is being connected (step S102 in FIG. 4).

On the other hand, in a case where the session information Db indicates that the communication with the receiver 2 is disconnected (step S101: No) and the disconnection is not caused by receipt of a disconnection command from the receiver 2 (step S103 in FIG. 4: No), the data storage unit 131 of the sensor device 1 stores the sensor data Da in the memory 12 as illustrated in FIG. 3B (step S104 in FIG. 4). Whether the disconnection is caused by receipt of the disconnection command can be confirmed by inquiring at the communication control unit 130.

When communication with the receiver 2 is not possible (step S105 in FIG. 4: Yes), the communication control unit 130 performs communication disconnection processing (step S106 in FIG. 4). For example, in the wireless communication standards such as BLE, the receiver 2 as a master device periodically transmits an empty data packet even in a case where there is no content to be transmitted. The communication control unit 130 of the sensor device 1 which is a slave device performs the disconnection processing when the data packet from the receiver 2 that is being connected cannot be received for equal to or longer than a certain period.

When the wireless communication unit 11 receives the disconnection command from the receiver 2 (step S107 in FIG. 4: Yes), the communication control unit 130 performs disconnection processing of communication (step S106).

As described later, the receiver 2 transmits a read request command to the sensor device that is being connected when receiving a read instruction from the host device. When the wireless communication unit 11 receives the read request command from the receiver 2 while the communication with the receiver 2 is being continued (step S108 in FIG. 4: Yes), the data reading unit 132 of the sensor device 1 reads the sensor data Da stored in the memory 12 and passes the sensor data Da to the communication control unit 130. The communication control unit 130 stores the sensor data Da received from the data reading unit 132 in a packet and passes the packet to the wireless communication unit 11. The wireless communication unit 11 wirelessly transmits the packet received from the communication control unit 130 to the receiver 2 that is being connected (step S109 in FIG. 4).

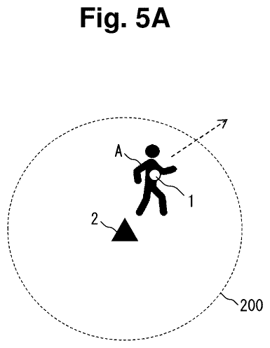

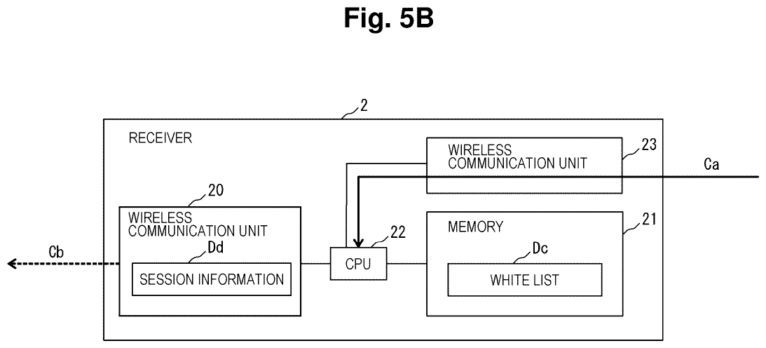

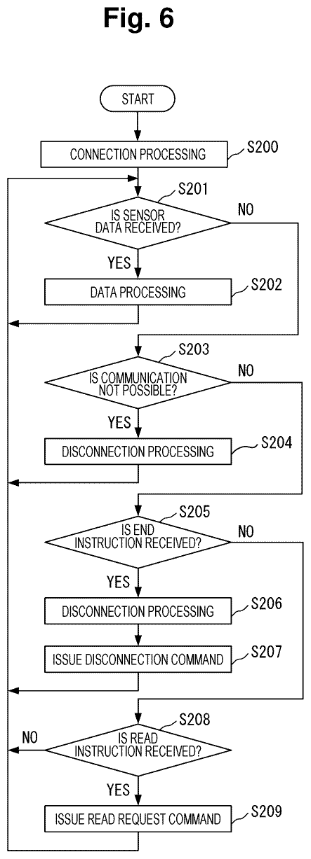

FIGS. 5A and 5B are views for explaining operation of the receiver 2, and FIG. 6 is a flowchart for explaining the operation of the receiver 2.

The memory 21 of the receiver 2 stores a white list Dc in which addresses of the sensor devices 1 permitted to be connected to the receiver 2 are registered in advance.

The communication control unit 220 of the receiver 2 refers to the white list Dc and performs connection processing with the sensor device 1 registered in the white list Dc (step S200 in FIG. 6). After completion of the connection processing, when the wireless communication unit 20 receives the data packet storing the sensor data Da from the sensor device 1 (step S201 in FIG. 6: Yes), the communication control unit 220 extracts the sensor data Da from the received data packet and stores the sensor data Da in the memory 21.

The data processing unit 221 of the receiver 2 performs predetermined processing on the sensor data Da stored in the memory 21 (step S202 in FIG. 6). Examples of the processing here include calculation processing, transfer of the sensor data Da to the host device, and the like.

While not explicitly illustrated in FIG. 6, the communication control unit 220 of the receiver 2 as a master device periodically transmits an empty data packet to the sensor device 1 that is being connected even in a case where there is no content to be transmitted. On the other hand, the communication control unit 130 of the sensor device 1, which is a slave device, returns a response packet.

When communication with the sensor device 1 is not possible (step S203 in FIG. 6: Yes), the communication control unit 220 performs disconnection processing of communication (step S204 in FIG. 6). For example, as illustrated in FIG. 5A, when a person A wearing the sensor device 1 goes out of a communicable area 200 of the receiver 2, the receiver 2 cannot receive the packet transmitted from the sensor device 1. In addition, also in a case where a wireless environment deteriorates, the packet from the sensor device 1 cannot be received. In this manner, in a situation where communication is not possible, which is not intended by the user of the sensor data collection system, the communication control unit 220 does not issue a disconnection command defined by the wireless communication standards such as BLE.

In addition, as illustrated in FIG. 5B, when the wireless communication unit 23 receives an operation end instruction Ca from the host device to be used by the user of the sensor data collection system (step S205 in FIG. 6: Yes), the communication control unit 220 performs disconnection processing of communication (step S206 in FIG. 6) and issues a disconnection command Cb to the sensor device 1 via the wireless communication unit 20 (step S207 in FIG. 6).

When the wireless communication unit 23 receives a read instruction from the host device (step S208 in FIG. 6), the communication control unit 220 issues a read request command to the sensor device 1 via the wireless communication unit 20 (step S209 in FIG. 6).

As described above, in the present embodiment, the disconnection is clearly distinguished between disconnection of communication intended by the user and unintended disconnection, the disconnection command is issued from the receiver 2 to the sensor device 1 in a case of the disconnection intended by the user, and the disconnection command is not issued in a case of the unintended disconnection. In the present embodiment, the sensor data is stored in the memory 21 of the sensor device 1 only in a case of the disconnection not intended by the user, and the sensor data is not stored in a case of the disconnection intended by the user, so that it is possible to reduce a possibility that the memory 21 becomes tight and operation of the sensor device 1 fails.

In addition, in the present embodiment, the disconnection command is not issued from the receiver 2 in a case where the communication is disconnected due to deterioration of the wireless environment, or the like, so that it is possible to reliably store the sensor data, and it is possible to significantly reduce loss of the sensor data. The sensor data stored in the memory 21 can be read by the read instruction from the host device. In the present embodiment, it is not necessary to store all the sensor data in the memory 21, which eliminates the need of a large-capacity memory as in the related art, so that it is possible to reduce cost of the sensor device 1. In addition, in the present embodiment, the method by delivery confirmation as disclosed in Non Patent Literature 4 is not used, and thus, the communication speed is not reduced due to the delivery confirmation.

### Second Embodiment

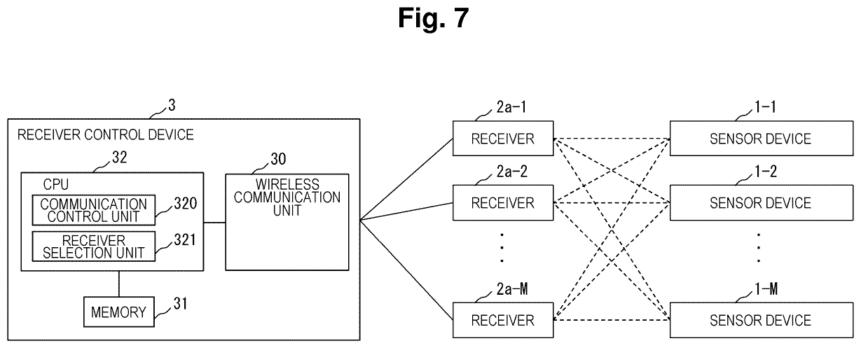

Next, a second embodiment of the present invention will be described. FIG. 7 is a block diagram illustrating a configuration of a sensor data collection system according to the second embodiment of the present invention. The sensor data collection system of the present embodiment includes a plurality of sensor devices 1-1 to 1-N (N is an integer equal to or greater than 2), a plurality of receivers 2a-1 to 2a-M (M is an integer equal to or greater than 2), and a receiver control device 3 having a function of selecting receivers 2a-1 to 2a-M to be connected to the sensor devices 1-1 to 1-N.

The receiver control device 3 includes a wireless communication unit 30 for communication with the receivers 2a-1 to 2a-M, a memory 31 for storing data and a program, and a CPU 32 that controls the entire receiver control device.

The CPU 32 executes processing according to the program stored in the memory 31 and functions as a communication control unit 320 and a receiver selection unit 321.

The sensor device 1 and the receiver 2 described in the first embodiment have a limited communication distance between the wireless communication units 11 and 20. In particular, in the wireless communication standards represented by BLE, transmission power is reduced in order to reduce power consumption, and thus, a communication distance is greatly limited. Thus, if a position of the receiver 2 is fixed with respect to the movable sensor device 1, in some cases, data from the sensor device 1 cannot be received, which limits a use environment of the user. If a plurality of receivers 2a-1 to 2a-M can be used, a communicable range can be expanded, so that usability is expected to be improved.

A configuration of each of the sensor devices 1-1 to 1-N is the same as that of the sensor device 1 of the first embodiment, and thus, description will be made using reference numerals in FIG. 1.

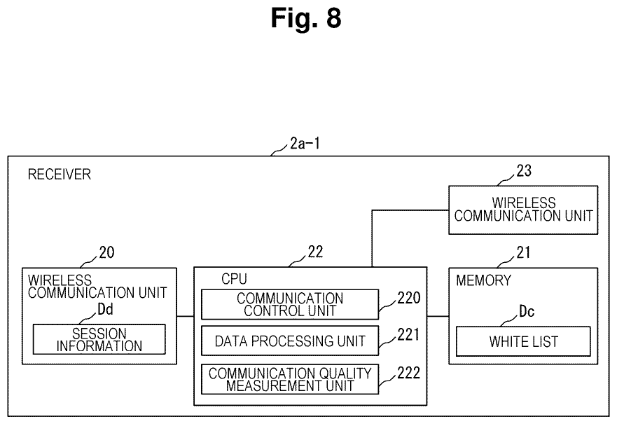

FIG. 8 is a block diagram illustrating a configuration of the receiver 2a-1. The receiver 2a-1 is a receiver in which a communication quality measurement unit 222 is added as a function to be implemented by the CPU 22 of the receiver 2 described in the first embodiment. While in the example of FIG. 8, the configuration of the receiver 2a-1 has been described, configurations of the receivers 2a-2 to 2a-M are also the same as that of the receiver 2a-1.

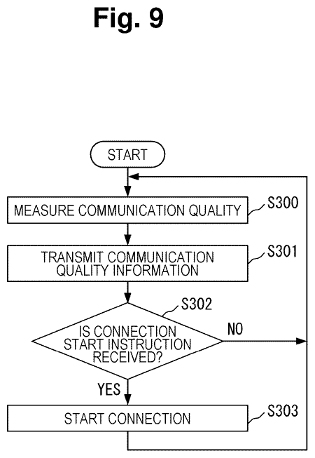

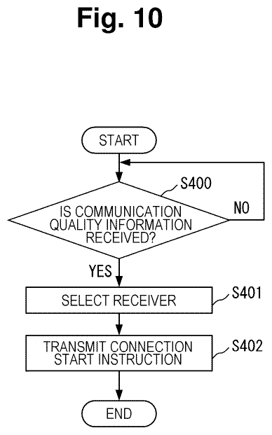

Next, operation of the sensor data collection system of the present embodiment will be described. FIG. 9 is a flowchart for explaining operation of each of the receivers 2a-1 to 2a-M, and FIG. 10 is a flowchart for explaining operation of the receiver control device 3.

The communication quality measurement unit 222 of each of the receivers 2a-1 to 2a-M acquires reception power of a wireless signal received from each of the sensor devices 1-1 to 1-N as communication quality information (step S300 in FIG. 9). A value of the reception power can be acquired from the wireless communication unit 20. The communication quality measurement unit 222 adds identification information (for example, an ID, an address, or the like, of the sensor device) that can uniquely identify the sensor device to the value of the reception power acquired for each of the sensor devices 1-1 to 1-N and passes the value of the reception power to the communication control unit 220.

The communication control unit 220 stores the value of the reception power received from the communication quality measurement unit 222 in a packet and passes the packet to the wireless communication unit 23. The wireless communication unit 23 wirelessly transmits the packet received from the communication control unit 220 to the receiver control device 3 (step S301 in FIG. 9).

Each receiver 2a-1 to 2a-M periodically transmits communication quality information as described above regardless of whether or not the receiver is connected to the sensor devices 1-1 to 1-N. Note that the reception power can dynamically vary depending on positions and angles of the sensor devices 1-1 to 1-N, whether or not there is a shield, and the like, and thus, it is preferable to acquire and transmit a median value, or the like, for a certain period as a representative value of the reception power.

When the wireless communication unit 30 receives the data packet storing the communication quality information (value of the reception power) from each of the receivers 2a-1 to 2a-M (step S400 in FIG. 10: Yes), the communication control unit 320 of the receiver control device 3 extracts the value of the reception power from the received data packet and passes the value of the reception power to the receiver selection unit 321.

The receiver selection unit 321 of the receiver control device 3 selects a receiver with the best quality of communication with the sensor device for each of the sensor devices 1-1 to 1-N based on the value of the reception power received from the communication control unit 320 (step S401 in FIG. 10). As described above, each of the receivers 2a-1 to 2a-M measures the value of the reception power for each of the sensor devices 1-1 to 1-N. The receiver selection unit 321 only requires to select a receiver having a maximum value of the reception power for each of the sensor devices 1-1 to 1-N.

The receiver selection unit 321 passes selection result information indicating the selected combination of the receivers 2a-1 to 2a-M and the sensor devices 1-1 to 1-N to the communication control unit 320. The selection result information is a combination of identification information (for example, an ID, an address, or the like, of the receiver) that can uniquely identify the receiver and identification information (for example, an ID, an address, or the like, of the sensor device) that can uniquely identify the sensor device.

Based on the selection result information received from the receiver selection unit 321, the communication control unit 320 of the receiver control device 3 passes, to the wireless communication unit 30, a packet of a connection start instruction that specifies a sensor device to be connected to each of the receivers 2a-1 to 2a-M. The wireless communication unit 30 wirelessly transmits the packet of the connection start instruction to each of the receivers 2a-1 to 2a-M that is a command target (step S402 in FIG. 10).

When the wireless communication unit 23 receives the packet of the connection start instruction from the receiver control device 3 (step S302 in FIG. 9: Yes), the communication control unit 220 of one of the receivers 2a-1 to 2a-M performs connection processing with the sensor device designated by the connection start instruction among the sensor devices 1-1 to 1-N (step S303 in FIG. 9).

The subsequent operation of the receivers 2a-1 to 2a-M is the same as the processing in and after step S201 in FIG. 6.

In addition, the operation of each of the sensor devices 1-1 to 1-N is the same as that of the sensor device 1 of the first embodiment.

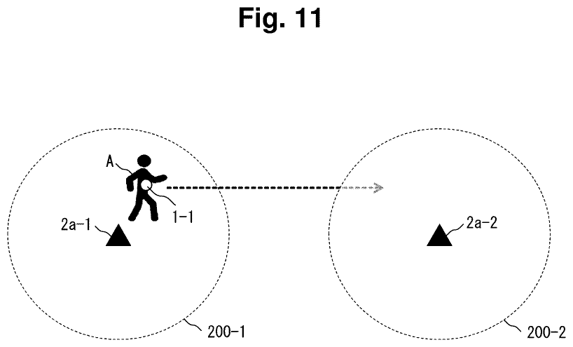

Thus, in the present embodiment, it is possible to select the receivers 2a-1 to 2a-M that are most suitable for connection with the sensor devices 1-1 to 1-N. For example, as illustrated in FIG. 11, if the person A wearing the sensor device 1-1 goes out of a communicable area 200-1 of the receiver 2a-1, the receiver 2a-1 cannot receive data transmitted from the sensor device 1-1.

When the sensor device 1-1 enters a communicable area 200-2 of the receiver 2a-2 along with movement of the person A, quality of communication between the sensor device 1-1 and the receiver 2a-2 is the best. Thus, the receiver 2a-2 performs connection processing with the sensor device 1-1 in accordance with a connection start instruction from the receiver control device 3. In this manner, data reception from the sensor device 1-1 can be resumed.

Note that the receiver control device 3 may always transmit a connection start instruction to each of the receivers 2a-1 to 2a-M regardless of whether the combination of the receivers 2a-1 to 2a-M and the sensor devices 1-1 to 1-N has changed, or may transmit a connection start instruction to the receiver whose combination has changed only in a case where the combination of the receivers 2a-1 to 2a-M and the sensor devices 1-1 to 1-N has changed.

In a case where the communication control unit 220 of one of the receivers 2a-1 to 2a-M that has received the connection start instruction has already been connected to the sensor device designated by the connection start instruction, it is only necessary to continue communication with the designated sensor device.

Furthermore, in a case where communication is disconnected due to deterioration of the wireless environment, or the like, the communication control unit 220 of one of the receivers 2a-1 to 2a-M can resume connection to the sensor device designated by the connection start instruction if the connection start instruction can be received from the receiver control device 3.

In the present embodiment, communication between the receiver control device 3 and the receivers 2a-1 to 2a-M is wireless communication, but may be wired communication.

### Third Embodiment

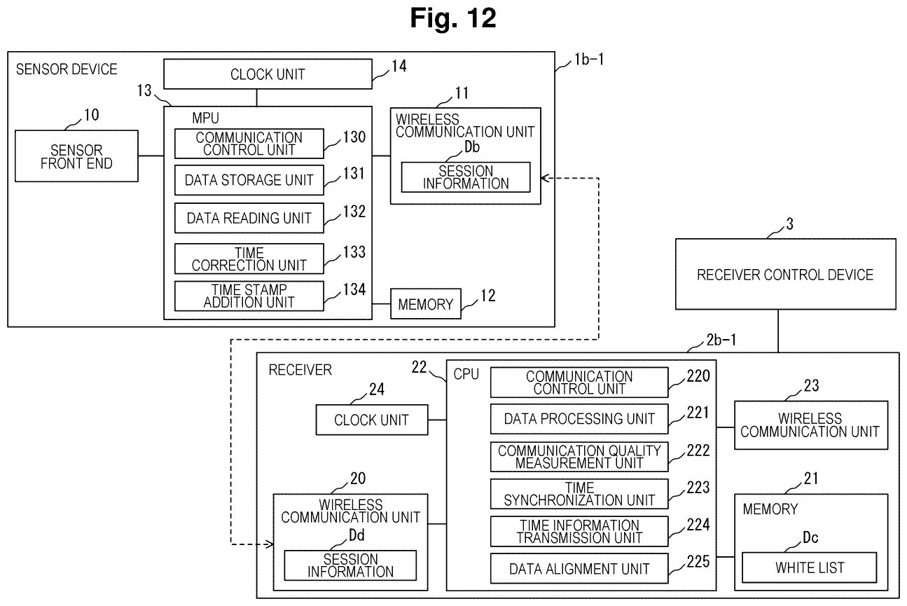

Next, a third embodiment of the present invention will be described. FIG. 12 is a block diagram illustrating a configuration of a sensor data collection system according to the third embodiment of the present invention.

A sensor device 1b-1 is a sensor device in which a clock unit 14 is added to the sensor device 1 described in the first and second embodiments, and a time correction unit 133 and a time stamp addition unit 134 are further added as functions to be implemented by the MPU 13.

A receiver 2b-1 is a receiver in which a clock unit 24 is added to the receiver 2a-1 described in the second embodiment, and a time synchronization unit 223, a time information transmission unit 224, and a data alignment unit 225 are further added as functions to be implemented by the CPU 22.

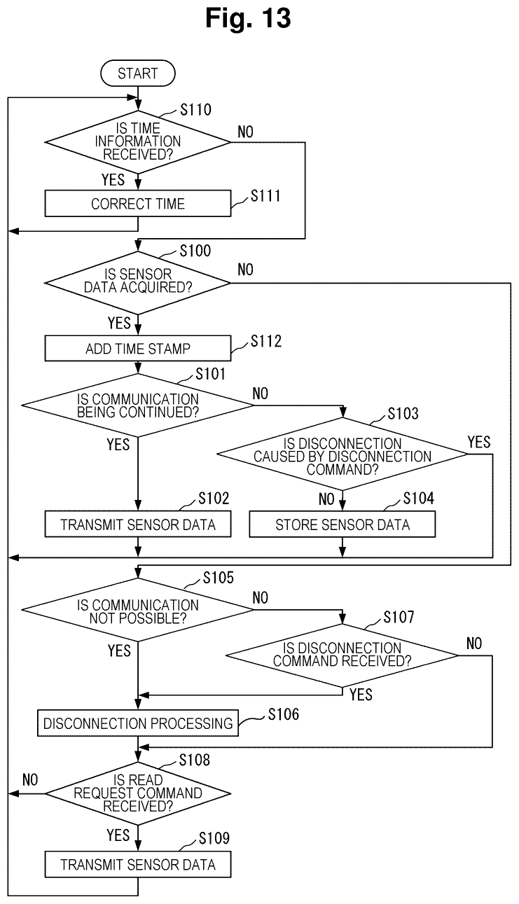

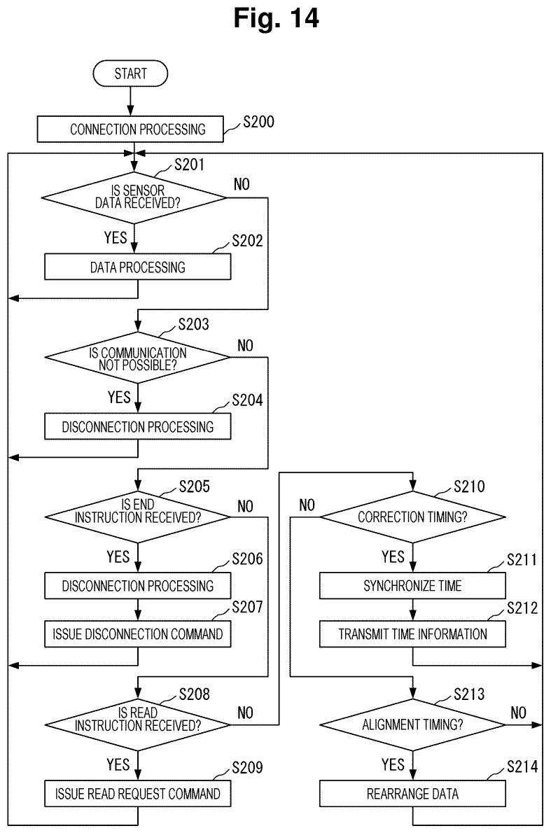

FIG. 13 is a flowchart for explaining operation of the sensor device 1b-1, and FIG. 14 is a flowchart for explaining operation of the receiver 2b-1.

The sensor device 1b-1 and the receiver 2b-1 include high-accuracy clock units 14 and 24 called real-time clock (RTC).

When the wireless communication unit 11 receives a data packet storing time information from the receiver 2b-1 that is being connected or other receivers that are being connected (step S110 in FIG. 13: Yes), the communication control unit 130 of the sensor device 1b-1 extracts the time information from the received data packet and passes the time information to the time correction unit 133. The time correction unit 133 corrects the time measured by the clock unit 14 based on the time information received from the communication control unit 130 (step S111 in FIG. 13).

In this event, the time measured by the clock unit 14 may be updated to the received time information, but the time correction unit 133 may calculate a propagation delay period between the sensor device 1b-1 and the receiver based on, for example, a time when the sensor device 1b-1 transmits the packet and a time when a response packet is received from the receiver, and correct a time lag of the clock unit 14 in consideration of the propagation delay period.

When the sensor data Da is acquired from the sensor front end 10 (step S100 in FIG. 13: Yes), the time stamp addition unit 134 of the sensor device 1b-1 acquires the time information from the clock unit 14 and adds a time stamp indicating the time information to the sensor data Da (step S112 in FIG. 13).

The communication control unit 130 of the sensor device 1b-1 refers to the session information Db managed by the wireless communication unit 11, and in a case where the session information Db indicates that communication with the receiver 2 is being continued (step S101 in FIG. 13: Yes), stores the sensor data Da to which the time stamp is added in a packet and passes the packet to the wireless communication unit 11. The wireless communication unit 11 wirelessly transmits the packet received from the communication control unit 130 to the receiver 2 that is being connected (step S102 in FIG. 13).

In a case where the session information Db indicates that communication with the receiver 2 is disconnected (step S101: No) and the disconnection is not caused by receipt of the disconnection command from the receiver 2 (step S103 in FIG. 13: No), the data storage unit 131 of the sensor device 1b-1 stores the sensor data Da to which the time stamp is added in the memory 12 (step S104 in FIG. 13). Other operation is the same as that of the sensor devices 1 and 1-1 to 1-N described in the first and second embodiments.

While in FIGS. 12 and 13, only one sensor device 1b-1 is described, configurations and operation of the other sensor devices are the same as those of the sensor device 1b-1.

Next, the operation of the receiver 2b-1 will be described. At a predetermined correction timing (step S210 in FIG. 14: Yes), the time synchronization unit 223 of the receiver 2b-1 corrects the time measured by the clock unit 24 (step S211 in FIG. 14). As a method of correcting the time in this event, for example, there is a method using a network time protocol (NTP), a global positioning system (GPS), or the like.

The time information transmission unit 224 of the receiver 2b-1 acquires the time information from the clock unit 24, stores the time information in a packet and passes the packet to the wireless communication unit 20. The wireless communication unit 20 wirelessly transmits the packet received from the time information transmission unit 224 to the sensor device 1b-1 that is being connected or other sensor devices that are being connected (step S212 in FIG. 14).

Thus, the times measured by the plurality of receivers can be synchronized by performing periodic time correction using the NTP, the GPS, or the like. Note that in FIG. 14, the timing at which the time is corrected is made the same as the timing at which the time information is transmitted, but it goes without saying that the time correction and the time information transmission may be performed at different timings.

Next, at a predetermined alignment timing (step S213 in FIG. 14: Yes), the data alignment unit 225 of the receiver 2b-1 rearranges the sensor data Da received from the sensor device 1b-1 that is being connected or other sensor devices that are being connected and stored in the memory 21 in time order indicated by the time stamp added to the sensor data Da (step S214 in FIG. 14).

Thus, in the present embodiment, the sensor data Da can be aligned in the order of time when the sensor data Da is acquired in the sensor device that is a transmission source by the periodic processing by the data alignment unit 225. Other operation is the same as that of the receivers 2a-1 to 2a-M described in the second embodiment.

While only one receiver 2b-1 is illustrated in FIGS. 12 and 14, configurations and operation of the other receivers are the same as those of the receiver 2b-1.

As described above, in the present embodiment, the time measured by the sensor device is corrected by the time information being transmitted from the receiver to the sensor device. The time stamp addition unit 134 of the sensor device adds the time stamp to the sensor data Da. The respective receivers need to be synchronized with each other and hold time information with less error. If the receivers are not synchronized, erroneous time information may be transmitted to the sensor device, and the order of data may be lost. Further, in the present embodiment, the order of the sensor data Da can be guaranteed by rearranging the sensor data Da based on the time stamp added to the sensor data Da.

Note that, while the sensor data Da is rearranged in each receiver in the present embodiment, the sensor data Da may be rearranged by a data alignment unit of the host device after the sensor data Da is transferred from the receiver to the host device.

Furthermore, while an example has been described in FIGS. 12 to 14 where the present embodiment is applied to the second embodiment, it goes without saying that the present embodiment may be applied to the first embodiment.

### Fourth Embodiment

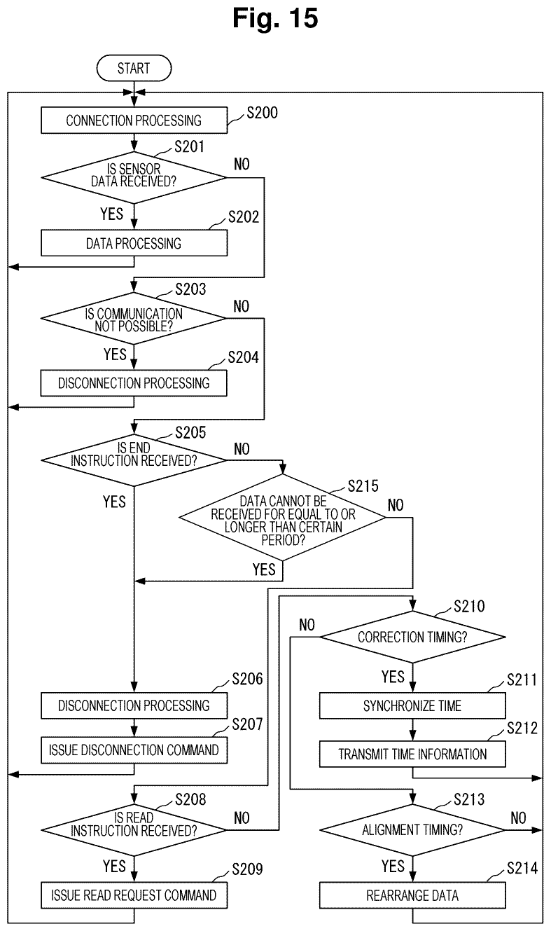

Next, a fourth embodiment of the present invention will be described. A configuration of the sensor data collection system of the present embodiment is similar to that of the third embodiment, for example, and thus will be described with reference to reference numerals in FIG. 12. FIG. 15 is a flowchart for explaining operation of a receiver 2b-1 of the present embodiment.

When the sensor data Da cannot be received from the sensor device that is being connected for equal to or longer than a certain period (step S215 in FIG. 15: Yes), the communication control unit 220 of the receiver 2b-1 performs disconnection processing of communication (step S206 in FIG. 15) and issues a disconnection command to the sensor device that is being connected via the wireless communication unit 20 (step S207 in FIG. 15). The other operation is the same as that of the receiver 2b-1 described in the third embodiment.

In the wireless communication standards including BLE and having a session, whether to maintain the session is confirmed by transmitting and receiving packets. In general, a size of a packet related to session maintenance is small, and transmission and reception tend to be easier than transmission of a packet storing sensor data Da.

Here, assuming that the sensor device is located at the end of the communicable area of the receiver 2b-1 and the wireless communication environment is in an unstable situation, although the session information indicates that communication is being continued because a packet for session maintenance defined in the wireless communication standards can be transmitted and received between the sensor device and the receiver 2b-1, there is a possibility that the packet storing the sensor data Da is difficult to reach the receiver 2b-1. If such a situation continues, the sensor device does not store the sensor data Da in the memory 12 because the session is valid, but the sensor data Da does not reach the receiver 2b-1, and there is a possibility that the intended data transfer is not performed.

Thus, in the present embodiment, in a situation where the session information Dd of the receiver 2b-1 indicates that communication with the sensor device is being continued (step S203 in FIG. 15: No), and when the sensor data Da cannot be received from the sensor device that is being connected for equal to or longer than a certain period, the receiver 2b-1 issues a disconnection command to the sensor device that is being connected.

In the present embodiment, in an extremely rare situation where the sensor device is located at the end of the communicable area of the receiver 2b-1, the connection between the sensor device and the receiver 2b-1 can be initialized, and stable operation of the system can be implemented.

While an example has been described in FIG. 15 where the present embodiment is applied to the third embodiment, it goes without saying that the present embodiment may be applied to the first and second embodiments.

In a case where the present embodiment is applied to the second embodiment or the third embodiment, the receivers 2a-1 to 2a-M, 2b-1 can resume connection to the sensor device according to the connection start instruction from the receiver control device 3 after executing the disconnection processing. Furthermore, in a case where the present embodiment is applied to the first embodiment, the receiver 2 attempts connection with the sensor device registered in the white list Dc after executing the disconnection processing.

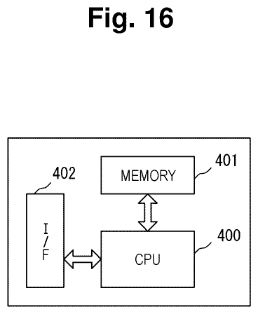

The communication control unit 220, the data processing unit 221, the communication quality measurement unit 222, the time synchronization unit 223, the time information transmission unit 224, and the data alignment unit 225 of each of the receivers 2, 2a-1 to 2a-M, 2b-1 described in the first to fourth embodiments can be implemented by a computer including a CPU, a memory, and an interface and a program for controlling these hardware resources. A configuration example of the computer is illustrated in FIG. 16.

The computer includes a CPU 400, a memory 401, and an interface device (I/F) 402. Hardware, or the like, of the clock unit 24 and the wireless communication units 20 and 23 is connected to the I/F 402. The CPU 400 (CPU 22) of each of the receivers 2, 2a-1 to 2a-M, 2b-1 executes the processing described in the first to fourth embodiments according to the sensor data collection program stored in the memory 401 (memory 21).

The sensor devices 1, 1-1 to 1-N, 1b-1 can also be implemented by a computer. The hardware, or the like, of the sensor front end 10, the clock unit 14, and the wireless communication unit 11 is connected to the I/F 402 of each of the sensor devices 1, 1-1 to 1-N, 1b-1. The CPU 400 (MPU 13) of each of the sensor devices 1, 1-1 to 1-N, 1b-1 executes the processing described in the first to fourth embodiments according to the sensor data collection program stored in the memory 401 (memory 12).

The receiver control device 3 can also be implemented by a computer. Hardware, or the like, of the wireless communication unit 30 is connected to the I/F 402 of the receiver control device 3. The CPU 400 (CPU 32) of the receiver control device 3 executes the processing described in the first to fourth embodiments according to the sensor data collection program stored in the memory 401 (memory 31).

In the computer as described above, a sensor data collection program for implementing a sensor data collection method of the present invention is provided in a state of being recorded on a recording medium such as a flexible disk, a CD-ROM, a DVD-ROM, or a memory card. Further, the program may also be provided via a network.

Some or all of the above-described embodiments may be described as the following supplementary notes, but are not limited to the following.

(Supplementary note 1) A sensor data collection system of the present invention includes: a sensor device configured to wirelessly transmit sensor data; and a receiver configured to receive the sensor data, the sensor device includes: a first communication control unit configured to control communication with the receiver; a first memory that stores the sensor data; and a data storage unit configured to store the sensor data in the first memory, the receiver includes: a second communication control unit configured to control communication with the sensor device, the first communication control unit of the sensor device wirelessly transmits the sensor data to the receiver in a case where communication with the receiver is being continued, and performs disconnection processing of communication when communication with the receiver is not possible or when a disconnection command is received from the receiver, the data storage unit of the sensor device stores the sensor data in the first memory in a case where communication with the receiver is disconnected and the disconnection is not caused by receipt of the disconnection command, and the second communication control unit of the receiver performs disconnection processing of communication when communication with the sensor device is not possible, and performs disconnection processing of communication and wirelessly transmits the disconnection command to the sensor device that is being connected when an operation end instruction is received from a host device.

(Supplementary note 2) In the sensor data collection system according to Supplementary note 1, the sensor device further includes a data reading unit configured to read the sensor data stored in the first memory when a read request command is received from the receiver, the first communication control unit of the sensor device wirelessly transmits the sensor data read by the data reading unit to the receiver that is being connected, and the second communication control unit of the receiver wirelessly transmits the read request command to the sensor device that is being connected when a read instruction is received from the host device.

(Supplementary note 3) The sensor data collection system according to Supplementary note 1, further includes: a receiver control device configured to select a receiver to be connected to the sensor device from a plurality of the receivers, each receiver further includes a communication quality measurement unit configured to acquire quality information of communication with a plurality of the sensor devices for each sensor device, the second communication control unit of each receiver transmits the quality information to the receiver control device, and when a connection start instruction is received from the receiver control device, performs connection processing with a sensor device designated by the connection start instruction, and the receiver control device includes: a receiver selection unit configured to select a receiver with the best quality of communication with the sensor device based on the received quality information for each sensor device, and a third communication control unit configured to receive the quality information transmitted from each receiver and transmit the connection start instruction designating the sensor device to be connected to the receiver that is a command target based on a selection result by the receiver selection unit.

(Supplementary note 4) In the sensor data collection system according to Supplementary note 3, each sensor device further includes: a first clock unit configured to measure a time; a time correction unit configured to correct the time measured by the first clock unit based on time information received from the receiver that is being connected; and a time stamp addition unit configured to add a time stamp indicating the time information acquired from the first clock unit to the sensor data when the sensor data indicating a measured physical amount is acquired, and each receiver further includes: a second clock unit configured to measure a time; a time synchronization unit configured to correct the time measured by the second clock unit so that times measured by the receivers are synchronized with each other, a time information transmission unit configured to wirelessly transmit time information acquired from the second clock unit to the sensor device that is being connected, a second memory that stores sensor data received from the sensor device that is being connected, and a data alignment unit configured to rearrange the sensor data stored in the second memory in time order indicated by the time stamp added to the sensor data.

(Supplementary note 5) In the sensor data collection system according to any one of Supplementary notes 1 to 4, the second communication control unit of the receiver performs disconnection processing of communication and wirelessly transmits the disconnection command to the sensor device that is being connected when the sensor data cannot be received from the sensor device for equal to or longer than a certain period in a situation where a packet for session maintenance can be transmitted and received to and from the sensor device that is being connected.

(Supplementary note 6) A sensor data collection method of the present invention includes: a first step of a sensor device wirelessly transmitting sensor data to a receiver that is being connected; a second step of the sensor device performing disconnection processing of communication when communication with the receiver is not possible or when a disconnection command is received from the receiver; a third step of the sensor device storing the sensor data in a memory of the sensor device in a case where communication with the receiver is disconnected and the disconnection is not caused by receipt of the disconnection command; a fourth step of the receiver performing disconnection processing of communication when communication with the sensor device is not possible; and a fifth step of the receiver performing disconnection processing of communication and wirelessly transmitting the disconnection command to the sensor device that is being connected when an operation end instruction is received from a host device.

(Supplementary note 7) The sensor data collection method according to supplementary note 6 further includes: a sixth step of the receiver wirelessly transmitting a read request command to the sensor device that is being connected when a read instruction is received from the host device; a seventh step of the sensor device reading the sensor data stored in the memory of the sensor device when the read request command is received from the receiver; and an eighth step of the sensor device wirelessly transmitting the sensor data read in the seventh step to the receiver that is being connected.

(Supplementary note 8) The sensor data collection method according to supplementary note 6 further includes: a sixth step of each receiver acquiring quality information of communication with a plurality of the sensor devices for each sensor device; a seventh step of each receiver transmitting the quality information to a receiver control device; an eighth step of the receiver control device receiving the quality information transmitted from each receiver; a ninth step of the receiver control device selecting a receiver with the best quality of communication with a sensor device based on the received quality information for each sensor device; a tenth step of the receiver control device transmitting a connection start instruction designating a sensor device to be connected to the receiver that is a command target based on a selection result in the ninth step; and an eleventh step of each receiver performing connection processing with the sensor device designated by the connection start instruction when the connection start instruction is received from the receiver control device.

(Supplementary note 9) The sensor data collection method according to supplementary note 8 further includes: a twelfth step of correcting a time measured by a clock unit of each receiver so that times measured by the receivers are synchronized with each other; a thirteenth step of each receiver wirelessly transmitting time information acquired from the clock unit of each receiver to the sensor device that is being connected; a fourteenth step of each sensor device correcting the time measured by the clock unit of each sensor device based on the time information received from the receiver that is being connected; a fifteenth step of each sensor device adding a time stamp indicating the time information acquired from the clock unit of each sensor device to the sensor data when the sensor data indicating a measured physical amount is acquired; and a sixteenth step of each receiver rearranging the sensor data stored in each memory in time order indicated by the time stamp added to the sensor data.

(Supplementary note 10) In the sensor data collection method according to any one of Supplementary notes 6 to 9, the fifth step includes a step of performing disconnection processing of communication and wirelessly transmitting the disconnection command to the sensor device that is being connected when the sensor data cannot be received from the sensor device for equal to or longer than a certain period in a situation where a packet for session maintenance can be transmitted and received to and from the sensor device that is being connected.

(Supplementary note 11) A sensor data collection program of the present invention causes a computer to execute each step described in any one of Supplementary notes 6 to 10.

### INDUSTRIAL APPLICABILITY

The present invention can be applied to a technology of collecting sensor data from a sensor device.

### REFERENCE SIGNS LIST

1, 1-1 to 1-N, 1 b-1 Sensor device
2, 2a-1 to 2a-M, 2b-1 Receiver
3 Receiver control device
10 Sensor front end
11, 20, 23, 30 Wireless communication unit
12, 21, 31 Memory
13 MPU
14, 24 Clock unit
22, 32 CPU
130, 220, 320 Communication control unit
131 Data storage unit
132 Data reading unit
133 Time correction unit
134 Time stamp addition unit
221 Data processing unit
222 Communication quality measurement unit
223 Time synchronization unit
224 Time information transmission unit
225 Data alignment unit
321 Receiver selection unit

1.-8. (canceled)

9. A sensor data collection system comprising:
a sensor device configured to wirelessly transmit sensor data; and
a receiver configured to receive the sensor data,
wherein the sensor device comprises:
a first communication controller configured to control communication with the receiver;
a first memory that stores the sensor data; and
a data storage device configured to store the sensor data in the first memory, the receiver comprises:
a second communication controller configured to control communication with the sensor device,
the first communication controller of the sensor device wirelessly transmits the sensor data to the receiver in a case where communication with the receiver is being continued, and performs disconnection processing of communication when communication with the receiver is not possible or when a disconnection command is received from the receiver,
the data storage device of the sensor device stores the sensor data in the first memory in a case where communication with the receiver is disconnected and the disconnection is not caused by receipt of the disconnection command, and
the second communication controller of the receiver performs disconnection processing of communication when communication with the sensor device is not possible, and performs disconnection processing of communication and wirelessly transmits the disconnection command to the sensor device that is being connected when an operation end instruction is received from a host device.

10. The sensor data collection system according to claim 9, wherein
the sensor device further comprises:
a data reader configured to read the sensor data stored in the first memory when a read request command is received from the receiver,
the first communication controller of the sensor device wirelessly transmits the sensor data read by the data reader to the receiver that is being connected, and
the second communication controller of the receiver wirelessly transmits the read request command to the sensor device that is being connected when a read instruction is received from the host device.

11. The sensor data collection system according to claim 9, further comprising:
a receiver control device configured to select a receiver to be connected to the sensor device from a plurality of receivers, wherein
each receiver further comprises a communication quality measurement circuit configured to acquire quality information of communication with a plurality of the sensor devices for each sensor device,
the second communication controller of each receiver transmits the quality information to the receiver control device, and when a connection start instruction is received from the receiver control device, performs connection processing with a sensor device designated by the connection start instruction, and
the receiver control device includes:
a receiver selector configured to select a receiver with the best quality of communication with the sensor device based on the received quality information for each sensor device; and
a third communication controller configured to receive the quality information transmitted from each receiver and transmit the connection start instruction designating the sensor device to be connected to the receiver that is a command target based on a selection result by the receiver selector.

12. The sensor data collection system according to claim 11, wherein
each sensor device further comprises:
a first clock circuit configured to measure a time;
a time correction circuit configured to correct the time measured by the first clock circuit based on time information received from the receiver that is being connected; and
a time stamp addition circuit configured to add a time stamp indicating the time information acquired from the first clock circuit to the sensor data when the sensor data indicating a measured physical amount is acquired,
each receiver further comprises:
a second clock circuit configured to measure a time;
a time synchronization circuit configured to correct the time measured by the second clock circuit so that times measured by the receivers are synchronized with each other;
a time information transmitter configured to wirelessly transmit time information acquired from the second clock circuit to the sensor device that is being connected;
a second memory that stores sensor data received from the sensor device that is being connected; and
a data alignment circuit configured to rearrange the sensor data stored in the second memory in time order indicated by the time stamp added to the sensor data.

13. The sensor data collection system according to claim 9, wherein
the second communication controller of the receiver performs disconnection processing of communication and wirelessly transmits the disconnection command to the sensor device that is being connected when the sensor data cannot be received from the sensor device for equal to or longer than a certain period in a situation where a packet for session maintenance can be transmitted and received to and from the sensor device that is being connected.

14. A sensor data collection method comprising:
wirelessly transmitting sensor data to a receiver that is being connected;
performing disconnection processing of communication when communication with the receiver is not possible or when a disconnection command is received from the receiver;
storing the sensor data in a memory of the sensor device in a case where communication with the receiver is disconnected and the disconnection is not caused by receipt of the disconnection command;
performing disconnection processing of communication when communication with the sensor device is not possible; and
performing disconnection processing of communication and wirelessly transmitting the disconnection command to the sensor device that is being connected when an operation end instruction is received from a host device.

15. The sensor data collection method according to claim 14, further comprising:
wirelessly transmitting a read request command to the sensor device that is being connected when a read instruction is received from the host device;
reading the sensor data stored in the memory of the sensor device when the read request command is received from the receiver; and
wirelessly transmitting the sensor data read out of the memory of the sensor device to the receiver that is being connected.

16. A non-transitory storage medium storing a sensor data collection program that when executed by one or more processors, cause the one or more processors to execute steps of:
wirelessly transmitting sensor data to a receiver that is being connected;
performing disconnection processing of communication when communication with the receiver is not possible or when a disconnection command is received from the receiver;
storing the sensor data in a memory of the sensor device in a case where communication with the receiver is disconnected and the disconnection is not caused by receipt of the disconnection command;
performing disconnection processing of communication when communication with the sensor device is not possible; and
performing disconnection processing of communication and wirelessly transmitting the disconnection command to the sensor device that is being connected when an operation end instruction is received from a host device.

17. The sensor data collection system according to claim 10, wherein
the second communication controller of the receiver performs disconnection processing of communication and wirelessly transmits the disconnection command to the sensor device that is being connected when the sensor data cannot be received from the sensor device for equal to or longer than a certain period in a situation where a packet for session maintenance can be transmitted and received to and from the sensor device that is being connected.

18. The sensor data collection system according to claim 11, wherein
the second communication controller of the receiver performs disconnection processing of communication and wirelessly transmits the disconnection command to the sensor device that is being connected when the sensor data cannot be received from the sensor device for equal to or longer than a certain period in a situation where a packet for session maintenance can be transmitted and received to and from the sensor device that is being connected.

19. The sensor data collection system according to claim 12, wherein
the second communication controller of the receiver performs disconnection processing of communication and wirelessly transmits the disconnection command to the sensor device that is being connected when the sensor data cannot be received from the sensor device for equal to or longer than a certain period in a situation where a packet for session maintenance can be transmitted and received to and from the sensor device that is being connected.

20. The non-transitory storage medium storing a sensor data collection program according to claim 16, the sensor data collection program further causing a computer to implement
wirelessly transmitting a read request command to the sensor device that is being connected when a read instruction is received from the host device;
reading the sensor data stored in the memory of the sensor device when the read request command is received from the receiver; and
wirelessly transmitting the sensor data read out of the memory of the sensor device to the receiver that is being connected.

21. The sensor data collection method according to claim 14, further comprising:
wirelessly transmitting a read request command to a sensor device that is being connected when a read instruction is received from a host device;
reading sensor data stored in a memory of the sensor device when the read request command is received from a receiver; and
wirelessly transmitting the sensor data read from the memory of the sensor device to the receiver that is being connected.

22. The sensor data collection method according to claim 14, further comprising:
acquiring quality information of communication with a plurality of sensor devices for each sensor device;
transmitting the quality information to a receiver control device;
selecting a receiver with best quality of communication with a sensor device based on the quality information for each sensor device; and
performing connection processing with a sensor device designated by a connection start instruction when the connection start instruction is received from the receiver control device.

23. The sensor data collection method according to claim 14, further comprising:
correcting a time measured by a clock circuit of a receiver so that times measured by receivers are synchronized with each other;
wirelessly transmitting time information acquired from the clock circuit of the receiver to a sensor device that is being connected;
correcting a time measured by a clock circuit of the sensor device based on the time information received from the receiver that is being connected;
adding a time stamp indicating time information acquired from the clock circuit of the sensor device to the sensor data when the sensor data indicating a measured physical amount is acquired; and
rearranging sensor data stored in a memory in time order indicated by the time stamp added to the sensor data.

24. The non-transitory storage medium storing a sensor data collection program according to claim 16, the sensor data collection program further causing the one or more processors to execute steps of:
wirelessly transmitting a read request command to a sensor device that is being connected when a read instruction is received from a host device;
reading sensor data stored in a memory of the sensor device when the read request command is received from a receiver; and
wirelessly transmitting the sensor data read from the memory of the sensor device to the receiver that is being connected.

25. The non-transitory storage medium storing a sensor data collection program according to claim 16, the sensor data collection program further causing the one or more processors to execute steps of:
acquiring quality information of communication with a plurality of sensor devices for each sensor device;
transmitting the quality information to a receiver control device;
receiving the quality information transmitted from each receiver;
selecting a receiver with best quality of communication with a sensor device based on the received quality information for each sensor device; and
transmitting a connection start instruction designating a sensor device to be connected to a receiver that is a command target based on a selection result.

26. The non-transitory storage medium storing a sensor data collection program according to claim 16, the sensor data collection program further causing the one or more processors to execute steps of:
correcting a time measured by a clock circuit so that times measured by receivers are synchronized with each other;
wirelessly transmitting time information acquired from the clock circuit to a sensor device that is being connected;
correcting a time measured by a clock circuit of the sensor device based on time information received from a receiver that is being connected;
adding a time stamp indicating time information acquired from the clock circuit of the sensor device to the sensor data when the sensor data indicating a measured physical amount is acquired; and
rearranging sensor data stored in a memory in time order indicated by the time stamp added to the sensor data.
